(19) United States
(12) Patent Application Publication
(10) Pub. No.: US 2016/0077725 A1
(43) Pub. Date: Mar. 17, 2016

(54) FIGURE DISPLAY APPARATUS, FIGURE DISPLAY METHOD, AND STORAGE MEDIUM STORING FIGURE DISPLAY PROGRAM

(71) Applicant: CASIO COMPUTER CO., LTD., Tokyo (JP)

(72) Inventor: Naoya MAEDA, Kokubunji-shi (JP)

(73) Assignee: CASIO COMPUTER CO., LTD., Tokyo (JP)

(21) Appl. No.: 14/854,773

(22) Filed: Sep. 15, 2015

(30) Foreign Application Priority Data
Sep. 16, 2014 (JP) 2014-188133

(51) Int. Cl. G06F 3/0484; G06F 3/0488

(52) U.S. Cl. CPC G06F 3/04847; G06F 3/0488; G06F 2203/04808

(57) ABSTRACT

According to one embodiment, a figure display apparatus includes a display, a touch panel, and a processor. The processor is configured to: cause the display to display a first figure; cause the display to display an operation display element for changing, in accordance with a user operation, a set value for determining the displayed first figure; cause the display to display a second figure being changed from the displayed first figure in accordance with a user operation of the displayed operation display element; and change a variation range of the set value by the operation display element in accordance with a user's multi-touch operation.

### CROSS-REFERENCE TO RELATED APPLICATIONS

This application is based upon and claims the benefit of priority from Japanese Patent Application No, 2014-188133, filed Sep. 16, 2014, the entire contents of which are incorporated herein by reference.

### BACKGROUND OF THE INVENTION

1. Field of the Invention

The present invention relates generally to a figure display apparatus which is suited to display a variation of a figure, a figure display method, and a storage medium storing a figure display program.

2. Description of the Related Art

Conventionally, in a graph scientific calculator including a function of displaying a graph corresponding to an arbitrary function expression, a set value of a coefficient included in the function expression is set as a parameter, and, while the coefficient value as this parameter is being varied, each corresponding graph figure is varied and displayed.

In addition, in a figure display apparatus which displays an arbitrary figure, such as a triangle or a rectangle, a degree of an angle or a length of a side of the figure is set as a parameter, and, while the value of the parameter is being varied, a variation of each corresponding figure is analyzed.

There is known a graph creating apparatus which displays, in two axes of an X axis and a Y axis, a bar graph which is configured to indicate numerical values of a plurality of targets. In this graph creating apparatus, only a certain range, which is set on an upper limit side of the X axis or Y axis of the bar graph, is enlarged by an arbitrary magnification (parameter) by an operation of a slider in one direction of the X axis or Y axis, and the enlarged range is displayed (see, for example, Jpn. Pat. Appln. KOKAI Publication No, 2012-203605).

There is thought a waveform display apparatus in which a scroll bar area and a scroll bar in the scroll bar area are displayed on one side of a screen on which all waveform graphs of measurement data are drawn. Based on a relative position of the scroll bar in the scroll bar area, partial sections in all waveform graphs displayed in the screen are associated and displayed (see, for example, Jpn. Pat. Appln. KOKAI Publication No. 2011-185911).

Conventionally, as in the above-described graph creating apparatus, a set value as a coefficient included in a graph expression is varied by a slider, and a graph figure of the graph expression is displayed in a display area. However, in order to change a variation range (minimum value, maximum value) for varying a set value of the coefficient by the slider from a default value (for example the minimum value is 1 and the maximum value is 5), a complicated operation for changing the variation range of the set value is needed.

For example, there is case in which a set value that is to be slightly varied by the slider, and there is a case in which the set value is to be largely varied by the slider. If the variation range of the set value by the slider is fixed, both of these cases cannot be satisfied at a time. In such cases, re-resetting is needed each time by opening the screen for setting (changing) the variation range of the set value, leading to a problem of degradation in operability.

### BRIEF SUMMARY OF THE INVENTION

The present invention has been made in consideration of the above-described problem, and the object of the invention is to provide a figure display apparatus which can easily change the variation range of a set value for varying a shape of a figure, and a control program thereof.

In general, according to one embodiment, a figure display apparatus includes a display, a touch panel, and a processor. The processor is configured to: cause the display to display a first figure; cause the display to display an operation display element for changing, in accordance with a user operation, a set value for determining the displayed first figure; cause the display to display a second figure being changed from the displayed first figure in accordance with a user operation of the displayed operation display element; and change a variation range of the set value by the operation display element in accordance with a user's multi-touch operation.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a front view illustrating an external appearance structure of a graph scientific calculator 10 according to an embodiment of a figure display apparatus of the present invention.

FIG. 2 is a front view illustrating an external appearance structure of a tablet terminal 10 in which an emulator of the graph scientific calculator 10 is implemented, FIG. 2 illustrating an emulator screen EM of the graph scientific calculator 10.

FIG. 3 is a block diagram illustrating a circuit configuration of the graph scientific calculator 10.

FIG. 4 is a flowchart illustrating a graph display control process which is executed by a graph mode of the graph scientific calculator 10.

FIG. 5 is a flowchart illustrating a slider change process which is involved in the graph display control process of the graph scientific calculator 10.

FIG. 6 is a flowchart illustrating a variation range minimum/maximum value-adaptive figure distinguishable display process, which is involved in the slider change process of the graph scientific calculator 10.

Parts (A), (B), (C) and (D) of FIG. 7 illustrate a display operation corresponding to a user operation based on the graph display control process of the graph scientific calculator 10.

Parts (A), (B), (C) and (D) of FIG. 8 illustrate a change operation (part 1) of a slider SL corresponding to a user operation according to the slider change process of the graph scientific calculator 10.

Parts (A) and (B) of FIG. 9 illustrate a slider [a]SL and a graph figure y2 corresponding to the change operation (part 1) of the slider SL of the graph scientific calculator 10.

Parts (A) and (B) of FIG. 10 illustrate a change operation (part 2) of the slider SL corresponding to a user operation according to the slider change process of the graph scientific calculator 10.

Parts (A1), (A2), (A3), (B), (C1), (C2), (C3) and (D) of FIG. 11 illustrate a change operation (part 3) of the slider SL corresponding to a user operation according to the slider change process of the graph scientific calculator 10.

FIG. 12 is a flowchart illustrating a figure display control process which is executed by a figure mode of the graph scientific calculator 10.

Parts (A) and (B) of FIG. 13 illustrate a display operation corresponding to a user operation based on the figure display control process of the graph scientific calculator 10.

### DETAILED DESCRIPTION OF THE INVENTION

Embodiments of the present invention will be described hereinafter with reference to the accompanying drawings.

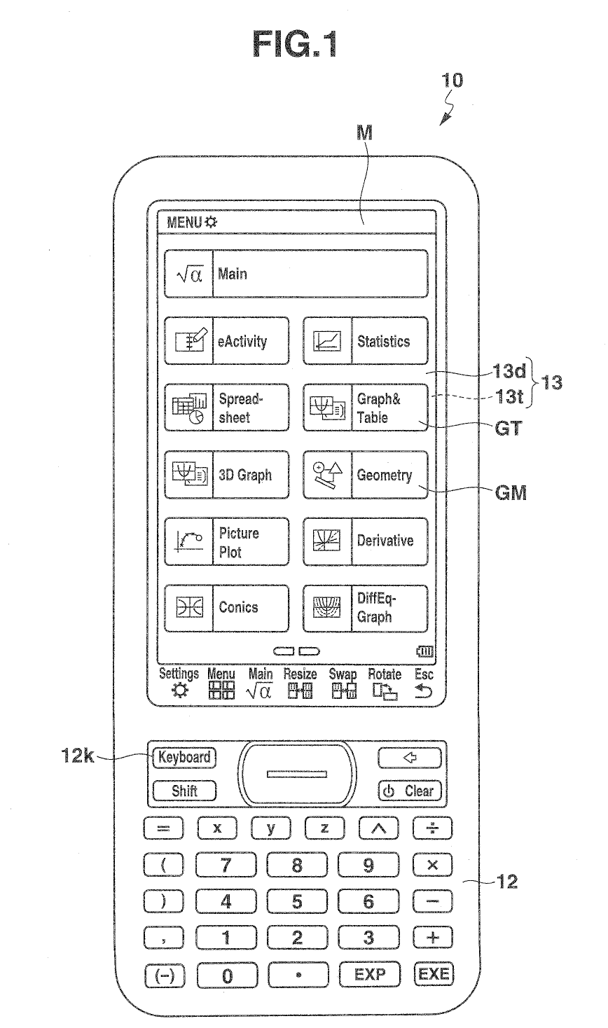

FIG. 1 is a front view illustrating an external appearance structure of a graph scientific calculator 10 according to an embodiment of a figure display apparatus of the present invention.

This figure display apparatus is implemented as a purpose-specific graph scientific calculator 10 which is to be described below, or is constructed as a tablet terminal, a mobile phone, a portable game console, or the like, which includes a graph display function and a figure display function.

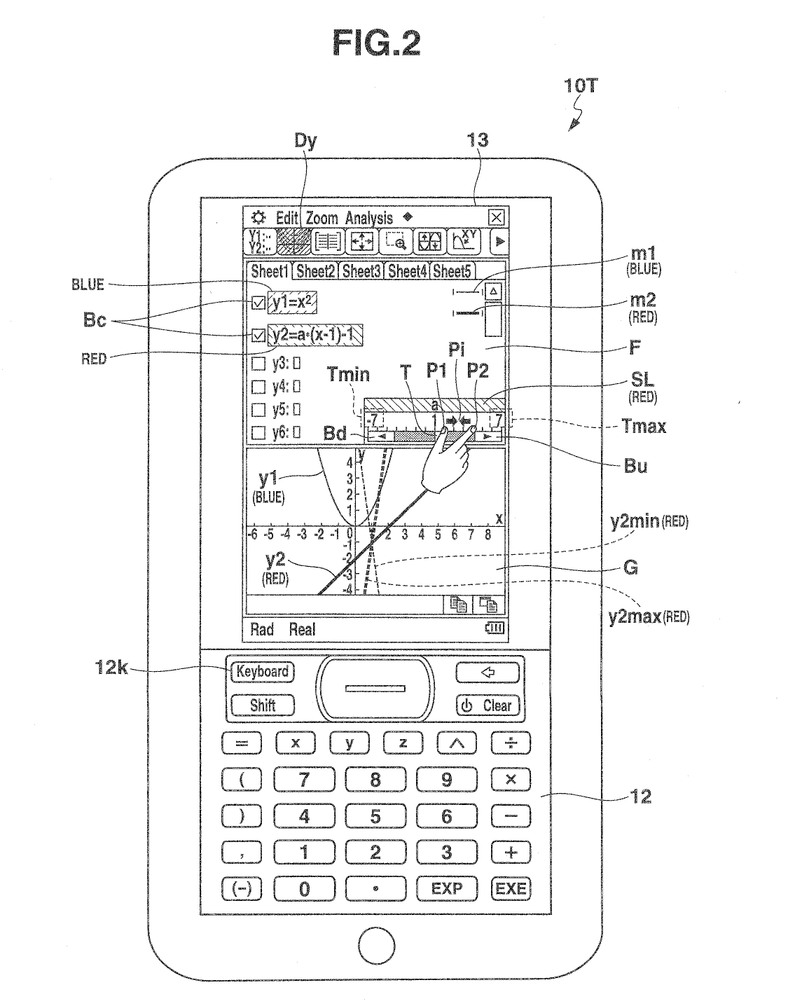

FIG. 2 is a front view illustrating an external appearance structure of a tablet terminal 10T in which an emulator of the graph scientific calculator 10 is implemented, FIG. 2 illustrating an emulator screen EM of the graph scientific calculator 10.

This graph scientific calculator 10 includes a function of displaying an input function expression and a graph corresponding to this function expression, and a function of displaying a figure which is input.

On the main body of this graph scientific calculator 10, a key input unit 12 is provided in a range of a lower part of about ⅓ of a front surface of the main body, and a touch panel display unit 13 is provided in a range of an upper part of about ⅔ of the front surface.

The key input unit 12 is equipped with numeral value/sign keys, function/operator keys, and a cursor key.

The numeral/sign keys are composed of an input key group of numerical values/signs, in which various numeral keys and sign keys are arranged.

The function/operator keys are composed of various function sign keys which are operated at a time of inputting an arithmetic expression or a function expression, and operator keys such as [+], [−], [×], [÷], and [=]. In the meantime, a [Keyboard] key 12k is operated at a time of displaying on the touch panel display unit 13 a software keyboard including kinds of keys which are not included in the keys that are prepared in advance on the key input unit 12. When inputting various functions, if a user first operates the [Keyboard] key 12k once, the software keyboard including various function keys is displayed on the lower side of the display unit. Thus, the user can input an arbitrary function key by a single key. In addition, if the user operates the [Keyboard] key 12k in the state in which the software keyboard is displayed, the software keyboard is deleted.

The touch panel display unit 13 is configured such that a transparent touch panel 13t is laid over a liquid crystal display screen 13d which is capable of effecting color display.

In this graph scientific calculator 10, a main menu M, as illustrated in FIG. 1, is displayed in accordance with a touch operation of a menu button [Menu] which is displayed along an upper end of the touch panel display unit 13. By selectively touch-operating various icons displayed on this main menu M, a transition occurs to an operation mode of a function corresponding to the touched icon.

In this embodiment, a description is given of an operation mode (graph mode) of a graph function which is started by a [Graph & Table] icon GT, and an operation mode (figure mode) of a figure display function which is started by a [Geometry] icon GM.

For example, as illustrated in FIG. 2, the graph mode includes a function of inputting function expressions y1, y2, which are desired by the user, in a graph expression area F displayed on the touch panel display unit 13, and distinguishably displaying display colors in association with the respective function expressions; a function of designating the function expressions y1, y2, which are targets of graph drawing, by adding check marks in check boxes Bc of the function expressions y1, y2; a function of displaying, in a graph area G, graph figures y1, y2 corresponding to the designated function expressions y1, y2, with the same display colors as the function expressions y1, y2; a function of displaying a slider (operation display element) [a]SL for changing, in accordance with a user operation, a set value of a coefficient a included in the function expression y2 with a coefficient of the functions expressions y1 and y2 designated as drawing targets (the set value of coefficient a is used for determining the shape of the graph figure), with the same display color as the function expression y2; a function of displaying the graph figure y2 by varying the graph figure y2 in accordance with the set value of the coefficient a, which is changed by a left button [←] Bd, a right button [→] Bu, or a tab T of the slider [a]SL; a function of widening or narrowing, in accordance with a touch operation by the user, the variation range (minimum value˜maximum value) of the coefficient value by the slider [a]SL (in FIG. 2, a function of narrowing the variation range by a pinch-in operation Pi of two-point touch P1, P2); and a function of distinguishably displaying a graph figure y2min in a case of setting the coefficient a of the function expression y2 at a minimum value of the variation range, and a graph figure y2max in a case of setting the coefficient a of the function expression y2 at a maximum value of the variation range.

Incidentally, Dy in FIG. 2 is an execution icon of a dynamic graph mode for displaying a graph figure yn corresponding to the function expression yn, while varying the coefficient value of the function expression yn.

For example, as illustrated in FIG. 13, the figure mode includes a function of drawing an arbitrary figure (in this example, a triangle ABC) on a figure area D which is opened by a drawing [Draw] function of a figure screen Ge; a function of selecting figure parts (side AB, side BC) of the drawn figure, adding a selection mark m to the selected figure parts, and distinguishably displaying the figure parts with thick lines; a function of designating, by a measurement item icon (angle icon Ia), an item of a measurable set value (measurement item: in this example, an angle ∠B formed between the side AB and side BC), based on the selected figure parts (side AB, side BC), and displaying the measurement value (60°) in a measurement box M; a function of displaying a slider (operation display element) [Angle]SL which changes the set value of the measurement item ∠B in accordance with a user operation; and a function of varying the figure ABC in accordance with the set value of the measurement item ∠3 which is changed by right and left buttons Bu and Bd and a tab T of the slider [Angle]SL, and displaying the varied figure ABC.

This figure mode, like the graph mode, includes a function of widening or narrowing, in accordance with a touch operation by the user, the variation range (minimum value˜maximum value) of the set value of the measurement item ∠B by the slider [Angle]SL (in FIG. 2, a function of narrowing the variation range by a pinch-in operation Pi of two-point touch P1, P2); and a function of distinguishably displaying a figure ∠Bmin in a case of setting the measurement item ∠B: of the figure ABC at a minimum value of the variation range, and a figure ∠Bmax in a case of setting the measurement item ∠B of the figure ABC at a maximum value of the variation range.

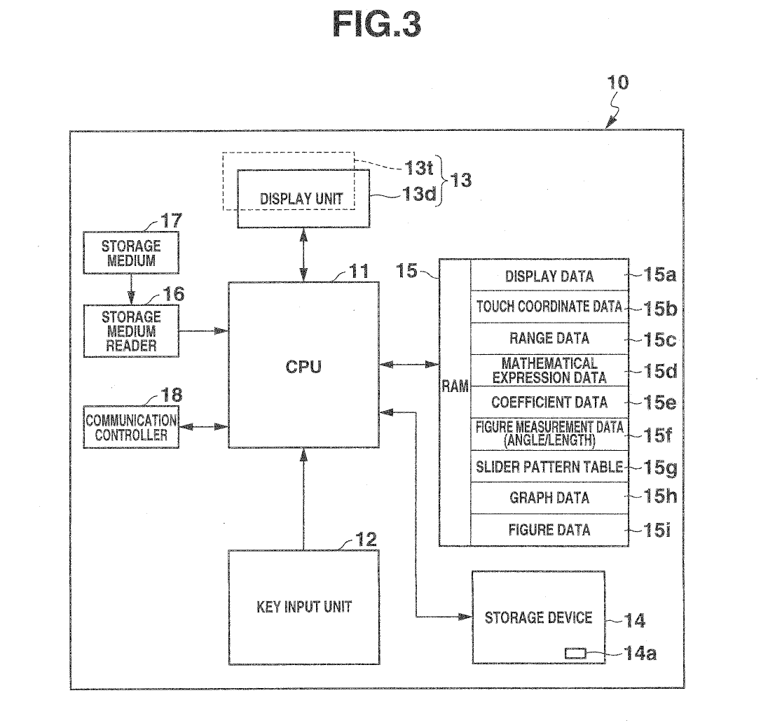

FIG. 3 is a block diagram illustrating a circuit configuration of the graph scientific calculator 10.

The graph scientific calculator 10 includes a CPU 11 which is a microcomputer.

In accordance with an electronic calculator control program 14a which is prestored in a storage device 14 such as a flash ROM, or an electronic calculator control program 14a which has been read in the storage device 14 from an external storage medium 17 such as a memory card via a storage medium reader 16, or an electronic calculator control program 14a which has been downloaded in the storage device 14 via a communication controller 18 from a Web server (program server) on a communication network (Internet), the CPU 11 controls the operations of the respective circuit components by using a RAM 15 as a working memory, and executes various functions provided in the graph scientific calculator 10, such as an electronic calculator function, a function graph drawing function, and a figure drawing function.

The storage device 14, RAM 15, storage medium reader 16 and communication controller 18, in addition to the key input unit 12 and touch panel display unit 13 shown in FIG. 1 (FIG. 2), are connected to the CPU 11.

The RAM 15 stores various data which are necessary for the processing operations of the CPU 11. The RAM 15 is provided with a display data storage area 15a on which data that is color-displayed on the screen of the touch panel display unit 13 is developed, and is also provided with a touch coordinate data storage area 15b, a range data storage area 15c, a mathematical expression data storage area 15d, a coefficient data storage area 15e, a figure measurement data storage area 15f, a slider pattern table 15g, a graph data storage area 15h, and a figure data storage area 15i.

In the touch coordinate data storage area 15b, coordinate data of a touch position corresponding to a user operation, which has been detected by the touch panel display unit 13, is stored.

In the range data storage area 15c, an X coordinate range (Xmin˜Xmax) and a Y coordinate range (Ymin˜Ymax), which indicate a display range of a graph that is set on the graph area G of the touch panel display unit 13 in the graph mode, are stored.

In the mathematical expression data storage area 15d, data relating to function expressions, y=f(x), which have been input by an operation of the key input unit 12, are stored together with data of display colors on the graph expression area F, which are individually set for a plurality of function expressions y1, y2, . . . . In this embodiment, five kinds of display colors are set. Namely, the display color of the function expression y1 is “blue”, the display color of y2 is “red”, the display color of y3 is “green”, the display color of y4 is “pink”, and the display color of y5 is “black”. For function expressions y6 onwards, these five kinds of display colors are repeatedly set.

In the coefficient data storage area 15e, data relating to a coefficient in each term included in the function expression, y=f(x), which is stored in the mathematical expression data storage area 15d, is stored together with a sign (e.g. a, b, c, . . . ) of the coefficient, and data of a set value that is set for the coefficient.

The figure measurement data storage area 15f stores data relating to parts (figure parts) of a measurement target, which were selected in accordance with a user operation for a figure displayed on the figure area D, and items of set values which are measurable in accordance with the figure parts (measurement items: angle, length, supplementary angle, inclination, inclination angle, distance, radius, circumference, area, expression, etc.).

In the slider pattern table 15g, data relating to the patterns of the sliders SL, which are operation display elements for changing, in accordance with a user operation, the set value of each coefficient a, . . . , stored in the coefficient data storage area 15e in the graph mode, and the set value of each measurement item stored in the figure measurement data storage area 15f in the figure mode, are stored together with data relating to the shape of the slider SL, the color of the slider SL, the number of change steps by the tab T of the slider SL, the number of change steps by the left and right buttons Bd and Bu, a variable minimum value (Min), a variable maximum value (Max), a current value (Current) and a variation amount (increment value: Step).

In the meantime, the variation amount (Step) of the set value, which is stored in the slider pattern table 15g, is the variation amount of a decrease or an increase corresponding to a one-time touch operation on the left button [←] Bd or right button [→] Bu of the slider SL. Aside from this, a variation amount corresponding to a movement unit in a movement range (minimum value (Min)˜maximum value (Max)) of the tab T of the slider SL is also stored.

In the graph data storage area 15h, data relating to graphs, which are generated based on the function expressions, y=f(x), stored in the mathematical expression data storage area 15d, and the set values of coefficients of the terms included in the function expressions, y=f(x), are stored as data indicative of positions of drawing of graphs corresponding to the plural function expressions y1, y2, . . . , and as data indicative of display colors of the graph figures y1, y2, . . . . In this case, the display color of each graph figure y1, y2, . . . , is set to be identical to the display color of the corresponding function expression yn.

Specifically, the display color of the function expression yn, which is stored in the mathematical expression data storage area 15d, the display color of the slider SL for varying the set value of the coefficient included in this function expression yn, which is stored in the slider pattern table 15g, and the display color of the graph figure yn corresponding to the function expression yn including the coefficient value varied by the slider SL, which is stored in the graph data storage area 15h, are identical.

In the figure data storage area 15i, the data of a figure, which was drawn on the figure area D, is stored as a combination of parts which constitute the figure.

In the graph scientific calculator 10 with the above-described structure, the CPU 11 controls the operations of the respective circuit components in accordance with various processing instructions described in the above-described electronic calculator control program 14a, and the software and hardware cooperate to realize various functions which will be described in the operational description below.

Next, the operation of the graph scientific calculator 10 with the above-described structure is described.

(Graph Mode)

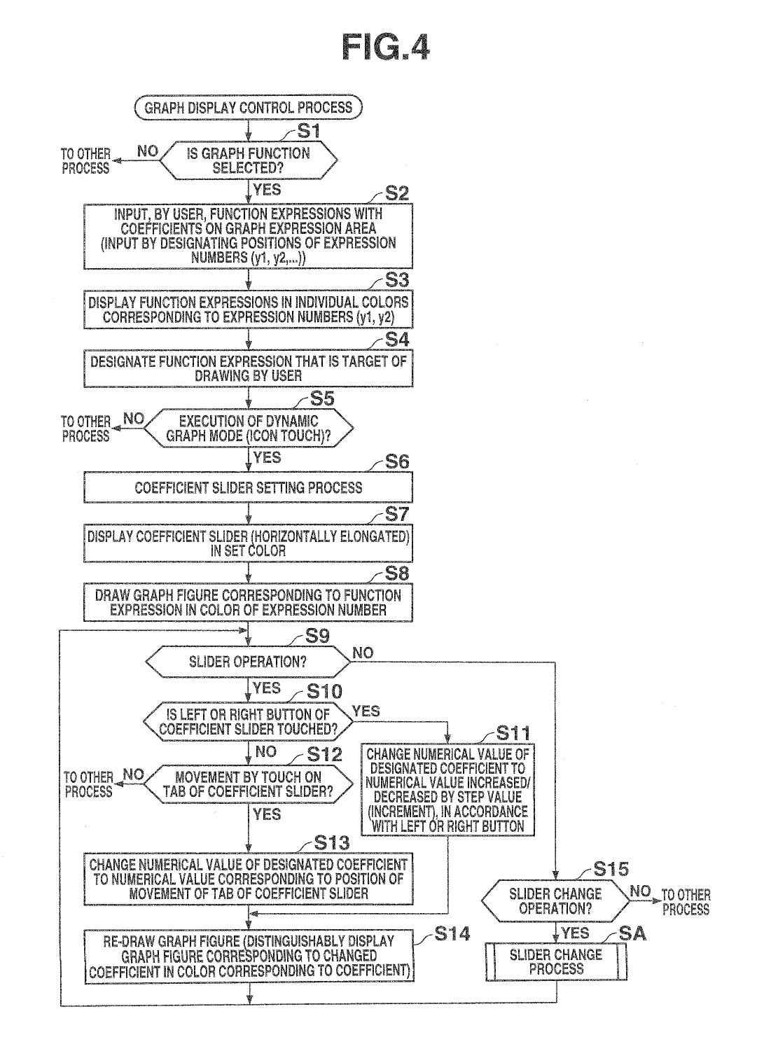

FIG. 4 is a flowchart illustrating a graph display control process which is executed by the graph mode of the graph scientific calculator 10.

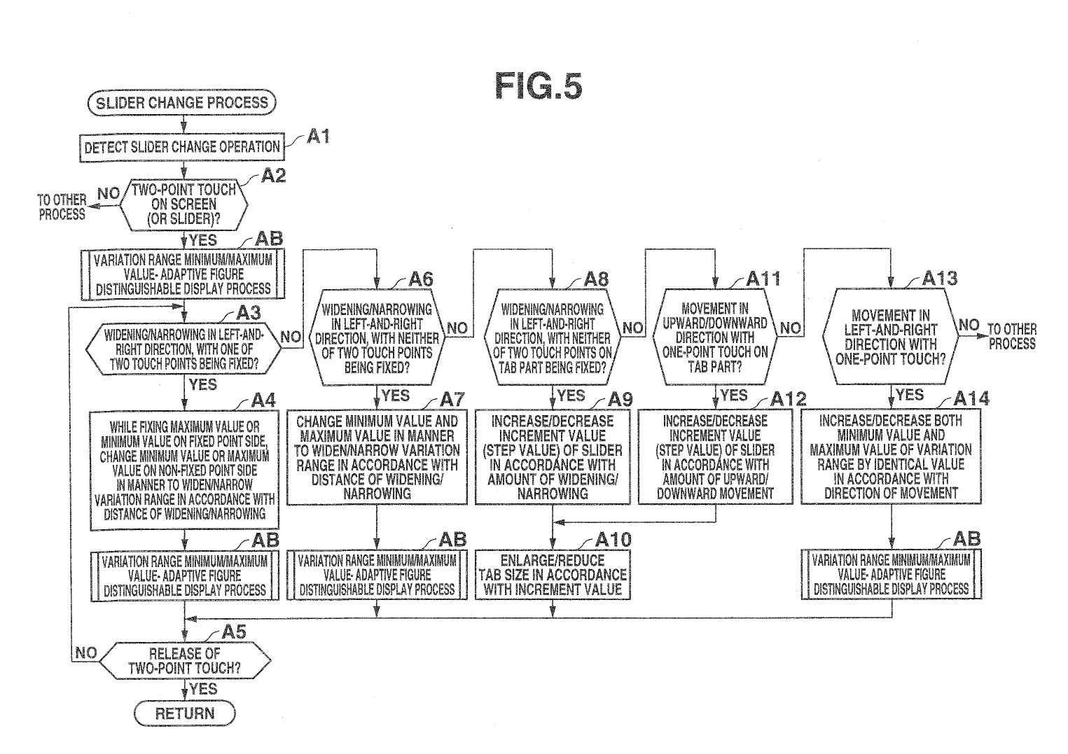

FIG. 5 is a flowchart illustrating a slider change process which is involved in the graph display control process of the graph scientific calculator 10.

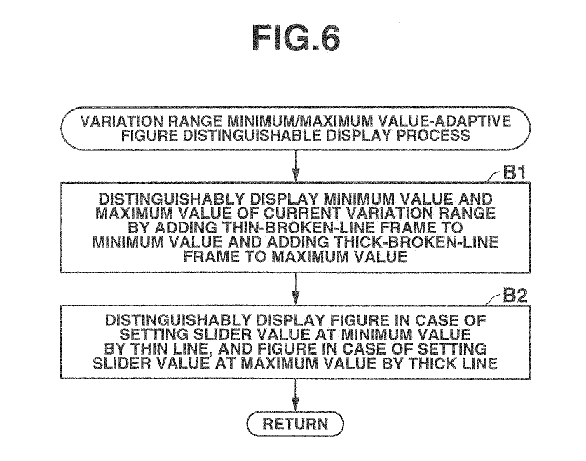

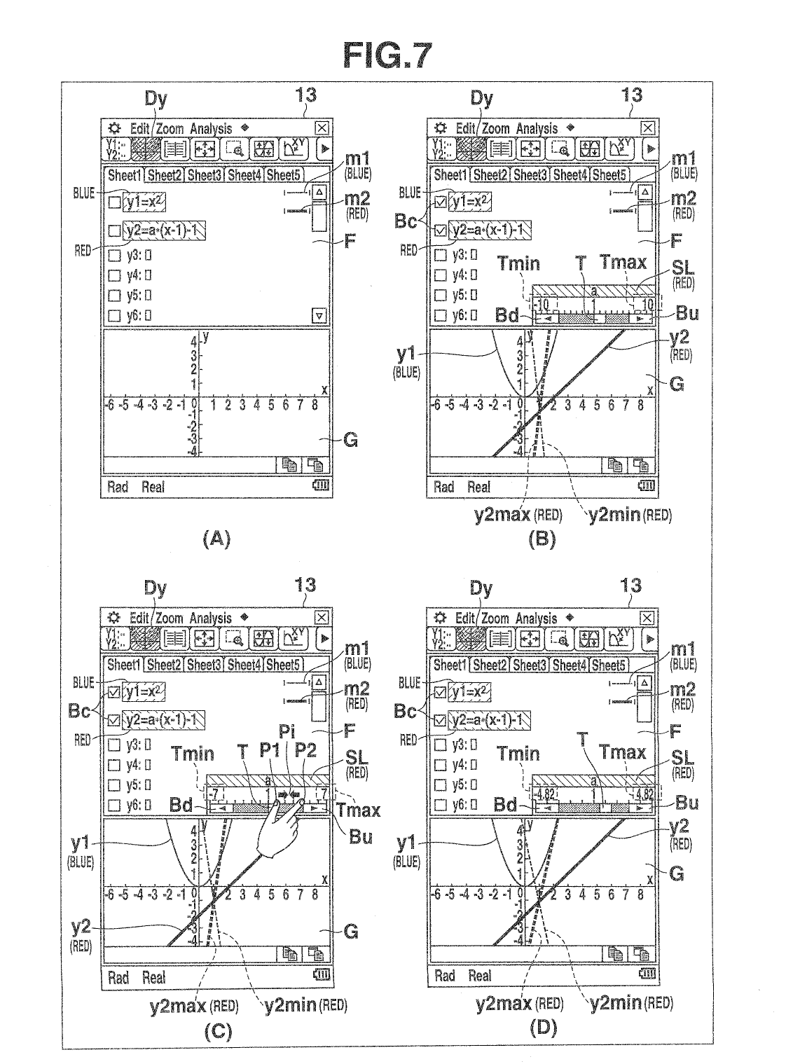

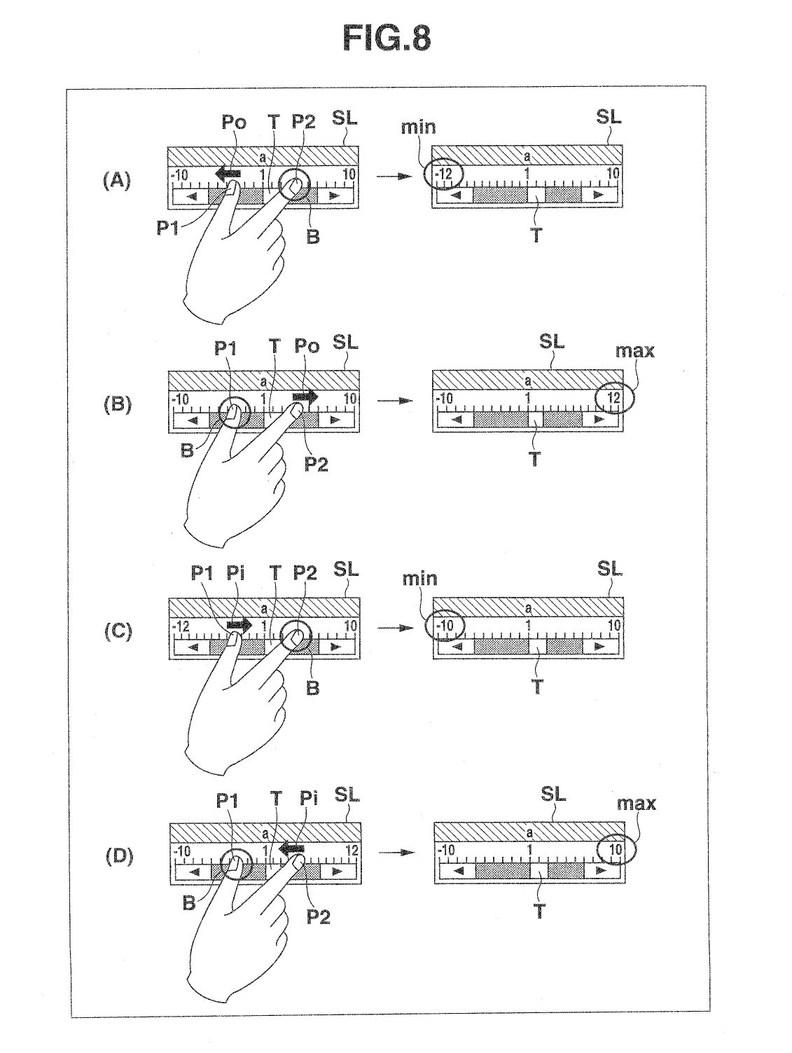

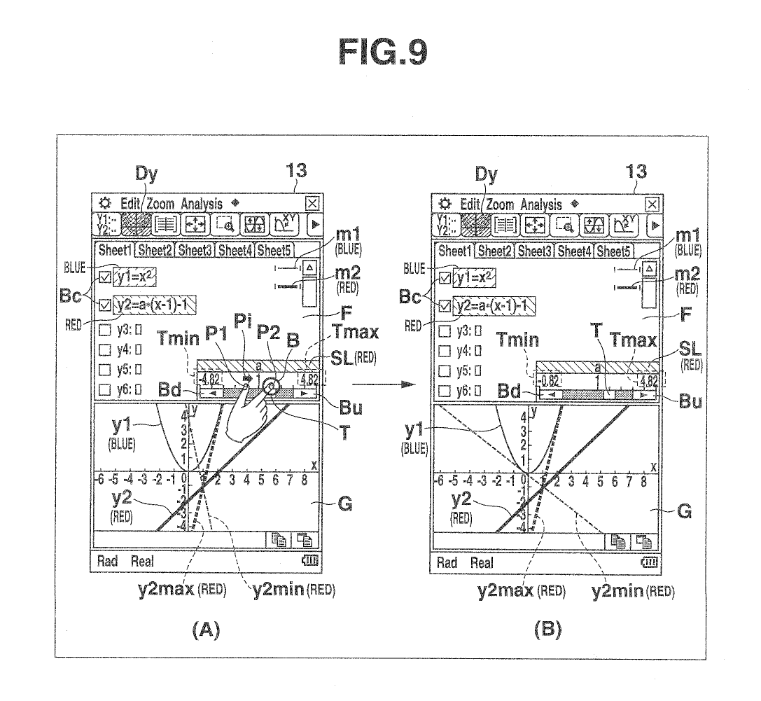

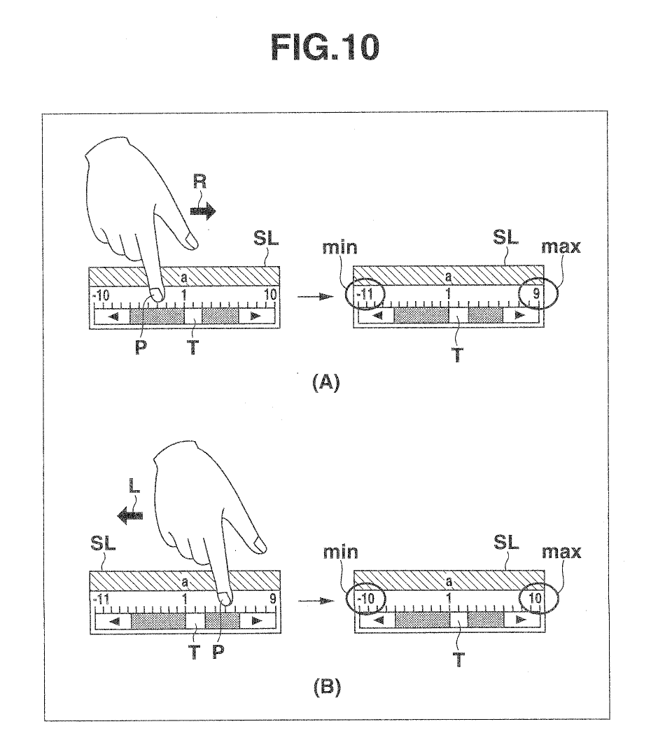

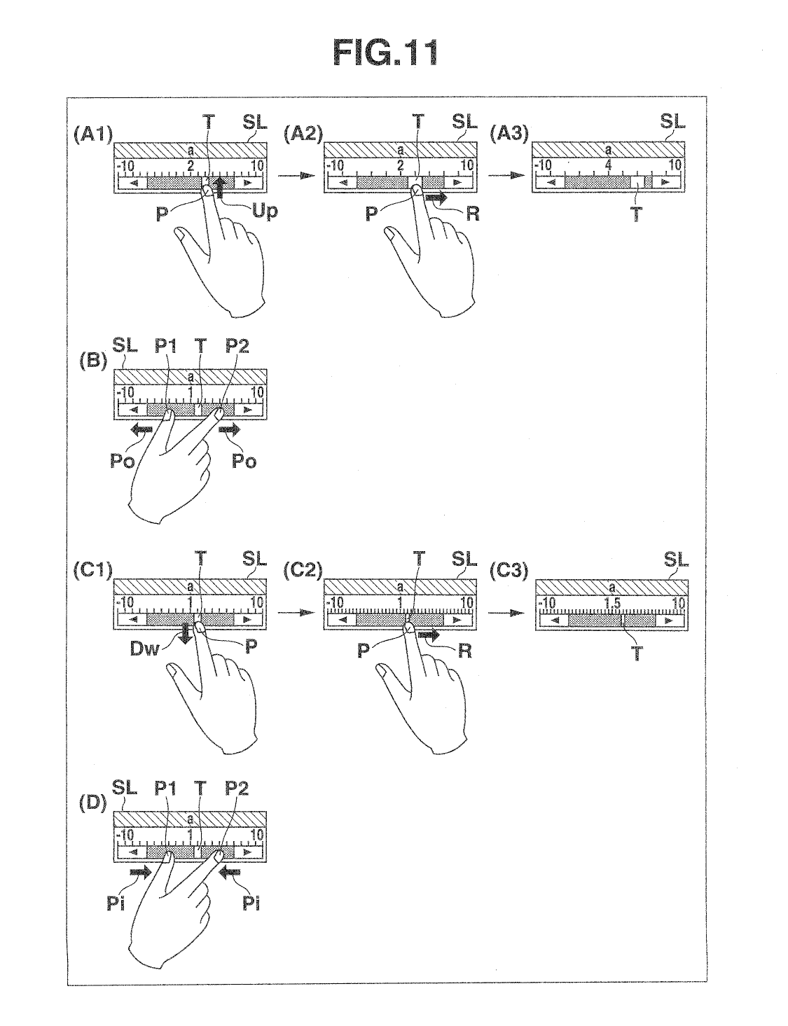

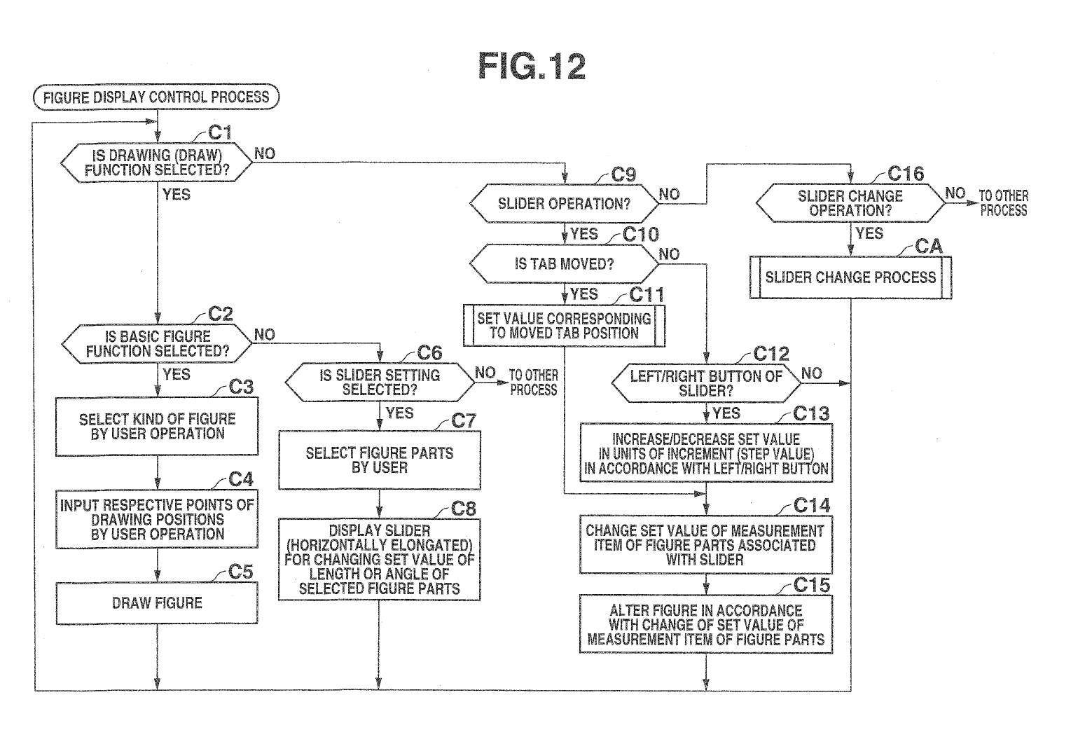

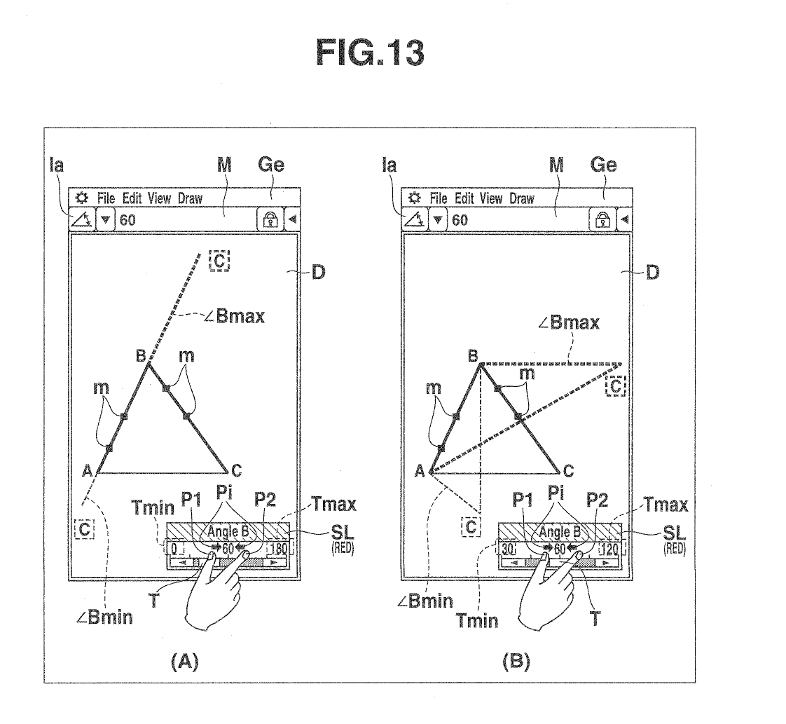

FIG. 6 is a flowchart illustrating a variation range minimum/maximum value-adaptive figure distinguishable display process, which is involved in the slider change process of the graph scientific calculator 10.

Parts (A), (B), (C) and (D) of FIG. 7 illustrate a display operation corresponding to a user operation based on the graph display control process of the graph scientific calculator 10.

If the [Graph & Table] icon GT is touch-operated and selected from a main menu (not shown) which is displayed on the touch panel display unit 13, the graph mode is started and, as illustrated in part (A) of FIG. 7, a graph expression area F and a graph area G are displayed on the upper-half area and lower-half area of the touch panel display unit 13, respectively (step S1 (Yes)).

In the graph expression area F, if the position of an expression number yn is designated by a touch operation and a function expression is input in accordance with an operation of the key input unit 12 (step S2), the input function expression is stored in the mathematical expression data storage area 15d and is displayed in a display color which is individually preset in accordance with the designated expression number yn (step S3).

In the present embodiment, a function expression, y1=x², which has been input, is displayed in blue, and a function expression, y2=a(x−1)−1, is displayed in red, and also drawing color marks m1 and m2, which indicate the drawing colors of line segments of graph figures corresponding to the respective function expressions y1 and y2, are displayed in the same colors as the display colors of the respective function expressions.

In this manner, in the graph expression area F in which the arbitrary function expressions y1 and y2 have been input, if check boxes Bc, which are located at the beginning of the function expressions, are touched and designated as illustrated in part (B) of FIG. 7, check marks are added to the function expressions y1 and y2 which are drawing targets of graph figures (step S4).

Of the function expressions y1 and y2 to which the check marks have been added, the function expression y2 includes a coefficient a. In order to display a variation of the graph figure corresponding to the function expression y2 while varying the coefficient a, if an execution icon Dy of a dynamic graph mode is touch-operated (step S5 (Yes)), a slider pattern of a slider [a]SL, which is associated with the coefficient a of the function expression y2, is set and stored in the slider pattern table 15g (step S6).

Specifically, as initial values for varying the coefficient a, the minimum value (Min) is set at “−10”, the maximum value (Max) is set at “10”, the variation amount (Step) is set at “1”, and the current value (Current) is set at “1”, and the display color of these values is set to be red that is the same color as the display color of the designated function expression y2, and the respective setting data are stored in the slider pattern table 15g.

Then, in the graph expression area F, the slider [a]SL, to which a bar of the set display color (red) is added, is displayed in a horizontally elongated shape (step S7).

Here, the slider [a]SL includes a left button [←] Ed and a right button [→] Bu for variable setting with a value corresponding to the set minimum value “−10”, maximum value “10”, current value “1” and variation amount “1”, and a tab T which is indicative of a current value in a bar-shaped variation range extending between the left and right buttons Bd and Bu. If the position of the tab T is moved in a left-and-right direction, a value, which corresponds to the moved position, is displayed as the current value in a numerical value area above the variation range.

Then, a graph figure y1 corresponding to the function expression, y1=x², and a graph figure y2 corresponding to the function expression with the coefficient, y2 a(x−1)−1, in which the set value of the coefficient a is the current value that was set as described above, are drawn in the graph data storage area 15h in accordance with the XY coordinate range stored in the range data storage area 15c. In addition, the graph figure y1 is displayed on the graph area G in blue that is the same display color as the function expression, y1=x², and also the graph figure y2 is displayed on the graph area G in red that is the same display color as the slider [a]SL of the coefficient a of the function expression, y2=a(x−1)−1 (step S8).

Here, in the case where the variation of the graph figure y2 is to be analyzed by changing the set value of the coefficient a of the function expression with the coefficient, y2=a(x−1)−1, if the left button [←] Ed or right button [,] Bu of the slider [a]SL is touch-operated (step S9, S10 (Yes)), the set value of the coefficient a corresponding to the slider [a]SL is changed to a value that was increased/decreased from the current value by a step-unit variation amount “1”, and the tab T is moved to the position corresponding to the changed set value of the coefficient a and is displayed (step S11).

Then, the graph figure y2, which corresponds to the function expression y2 after the change of the set value of the coefficient a by the slider [a]SL, is re-drawn, and updated and displayed on the graph area G (step S14).

In addition, if the tab T of the slider [a]SL is touch-operated and moved to the left or right (step S12 (Yes)), the set value of the coefficient a corresponding to the slider [a]SL is changed to a value corresponding to the position of the moved tab T (step S13).

Then, the graph figure y2, which corresponds to the function expression y2 after the change of the set value of the coefficient a by the slider [a]SL, is re-drawn, and updated and displayed on the graph area G (step S14).

On the other hand, in the case where the graph figure y2 is to be analyzed by making the graph figure y2 larger or smaller by widening or narrowing the present variation range [−10˜10] of the coefficient a by the slider [a]SL, if a part of the slider [a]SL, excluding the left button [←] Bd, right button [→] Bu and tab T, is continuously touch-operated and long-pressed for a predetermined time (e.g. three seconds) or more, it is determined that a change operation for changing the slider variation range was executed (step S15 (yes)), and a transition occurs to a slider change process illustrated in FIG. 5 (step SA).

In this slider change process, if the transition to the slider change process by the touch operation (long press) of the slider [a]SL was detected (step A1), a transition occurs to a determination standby state for determining whether a two-point touch operation is executed on the display screen or the slider [a]SL (step A2).

Here, if it is determined that a two-point touch operation P1, P2 was executed on the slider [a]SL (step A2 (Yes)), a variation range minimum/maximum value-adaptive figure distinguishable display process, which is illustrated in FIG. 6, is executed (step AB).

In this minimum/maximum value-adaptive figure distinguishable display process, a thin-broken-line frame Tmin, which surrounds a minimum value “−10” of the present variation range in the slider [a]SL, is displayed at the position of this minimum value “−10”. In addition, a thick-broken-line frame Tmax, which surrounds a maximum value “10” of the present variation range, is displayed at the position of this maximum value “10” (step B1).

Besides, a graph figure y2min in a case of setting the set value of the coefficient a of the function equation y2 with the coefficient at the minimum value “−10” of the present variation range of the slider [a]SL, is distinguishably displayed by a thin broken line. In addition, a graph figure y2max in a case of setting the set value of the coefficient a at the maximum value “10”, is distinguishably displayed by a thick broken line (step B2).

Thereby, the user can view the graph figure y2min in the case of setting the set value of the coefficient a at the minimum value by the slider [a]SL and the graph figure y2max in the case of setting the set value of the coefficient a at the maximum value, which are distinguished from the graph figure y2 corresponding to the current value, without operating the left/right button Bd, Bu or the tab T. Incidentally, it is possible to display either the graph figure y2min in the case of setting the set value of the coefficient a at the minimum value or the graph figure y2max in the case of setting the set value of the coefficient a at the maximum value.

In the meantime, although the variation range minimum/maximum value-adaptive figure distinguishable display process of the slider [a]SL is configured to be executed in accordance with the determination (step A2 (Yes)) of the two-point touch operation P1, P2 on the display screen or on the slider [a]SL, the minimum/maximum value-adaptive figure distinguishable display process may be configured to be immediately executed when the transition to the slider change process has been detected (step A1).

Then, if it is determined that, as illustrated in part (C) of FIG. 7, a two-point touch P1, P2 was executed on the scale of the slider [a]SL and the two touched points were widened (pinch-out Po) or narrowed (pinch-in Pi) in the left-and-right direction without being fixed (step A6 (Yes)), the minimum value and maximum value of the variation range of the slider [a]SL are changed so that the variation range becomes wider or narrower in accordance with an widened distance or a narrowed distance between the two touch points P1 and P2 (step A7).

In concrete examples illustrated in parts (B), (C) and (D) of FIG. 7, in accordance with pinch-in Pi by the two-point touch P1, P2 on the scale of the slider [a]SL, the variation range [−10˜10] of the slider [a]SL is changed to [−7˜7] in part (C) of FIG. 7, and is further changed to [−4.82˜4.82] in part (D) of FIG. 7.

Then, each time the variation range of the slider [a]SL, is changed, the variation range minimum/maximum value-adaptive figure distinguishable display process is executed like the above (step A5 (No)→A6, A7, AB), and the thin-broken-line frame Tmin surrounding the minimum value of the slider [a]SL and thick-broken-line frame Tmax surrounding the maximum value of the slider [a]SL are distinguishably displayed (step B1). Furthermore, the graph figure y2min in the case of setting the coefficient a at the minimum value is distinguishably displayed by the thin broken line and the graph figure y2max in the case of setting the coefficient a at the maximum value is distinguishably displayed by the thick broken line (step B2).

Thereby, the variation range of the coefficient a can be narrowed or widened by the simple operation, that is, the pinch operation (Pi/Po) on the slider [a]SL. Moreover, the graph figure y2min and graph figure y2max, which correspond to the minimum value and maximum value of the variation range, can easily be confirmed, and the variation of the graph figure y2, which corresponds to the function expression y2 with the coefficient, can be analyzed with high predictability.

Parts (A), (B), (C) and (D) of FIG. 8 illustrate a change operation (part 1) of the slider SL corresponding to a user operation according to the slider change process of the graph scientific calculator 10.

Parts (A) and (B) of FIG. 9 illustrate a display operation of the slider [a]SL and graph figure y2 corresponding to the change operation (part 1) of the slider SL of the graph scientific calculator 10.

As illustrated in parts (A) to (D) of FIG. 8, if it is determined that a two-point touch P1, P2 was executed on the scale of the slider [a]SL and one touch point P1 (or P2) is fixed (B) while the other touch point P2 (or P1) is pinched out (pinch-out Po) or pinched in (pinch-in Pi) in the left-and-right direction (step A3 (Yes)), the minimum value (or maximum value) of the variation range, which exists in the direction of the fixed (B) point P1 (or P2), is fixed, and the maximum value (or minimum value) of the variation range, which exists in the direction of the pinched-out point P2 (or P1) or pinched-in point P2 (or P1), is changed in a manner to increase or decrease in accordance with the widened or narrowed distance (step A4).

Specifically, as illustrated in part (A) of FIG. 8, if the right-side point P2 of the two touch points P1 and P2 is fixed (B) and the left-side point P1 is pinched out (Po) to the left, the minimum value “−10” of the variation range is changed to “−12” (min) in accordance with the widened distance of the point P1 to the left.

In addition, as illustrated in part (B) of FIG. 8, if the left-side point P1 of the two touch points P1 and P2 is fixed (B) and the right-side point P2 is pinched out (Po) to the right, the maximum value “10” of the variation range is changed to “12” (max) in accordance with the widened distance of the point P2 to the right.

Furthermore, as illustrated in part (C) of FIG. 8, if the point P2 is fixed (B) and the left-side point P1 is pinched in (Pi) to the right, the minimum value “−12” of the variation range is changed to “−10” (min) in accordance with the narrowed distance of the point P1 to the right.

Besides, as illustrated in part (D) of FIG. 8, if the point P1 is fixed (B) and the right-side point P2 is pinched in (Pi) to the left, the maximum value “12” of the variation range is changed to “10” (max) in accordance with the narrowed distance of the point P2 to the left.

Specifically, as illustrated in part (A) of FIG. 9, like the case of FIG. 7, in the state in which the graph expression area F of function expressions y1 and y2 and the graph area G of graph figures y1 and y2 corresponding to the function expressions y1 and y2 are displayed, and in which the sider [a]SL having the variation range with “minimum value˜maximum value” set as “−4.82˜4.82” is displayed, if the right-side point P2 of the two-point touch P1, P2 is fixed (B) and the left-side point P1 is pinched in (Pi) to the right, the minimum value “−4.82” of the variation range is changed to “−0.82” in accordance with the narrowed distance of the point P1 to the right, as illustrated in part (B) of FIG. 9 (step A3, A4).

Then, like the above, the variation range minimum/maximum value-adaptive figure distinguishable display process is executed (step AB), and the thin-broken-line frame Tmin, which surrounds the minimum value of the slider [a]SL, and the thick-broken-line frame Tmax, which surrounds the maximum value, are distinguishably displayed (step B1). Further, the graph figure y2min in the case of setting the coefficient a at the minimum value is distinguishably displayed by a thin broken line, and the graph figure y2max in the case of setting the coefficient a at the maximum value is distinguishably displayed by a thick broken line (step B2).

Thereby, the variation range of the coefficient a can be narrowed or widened by the simple operation, that is, the pinch operation (Pi/Po) on the slider [a]SL, with one of the two touch points P1 and P2 being fixed. Moreover, the graph figure y2min and graph figure y2max, which correspond to the minimum value and maximum value of the variation range, can easily be confirmed, and the variation of the graph figure y2, which corresponds to the function expression y2 with a coefficient, can be analyzed with high predictability.

Parts (A) and (B) of FIG. 10 illustrate a change operation (part 2) of the slider SL corresponding to a user operation according to the slider change process of the graph scientific calculator 10.

As illustrated in parts (A) and (B) of FIG. 10, if it is determined that a one-point touch P was executed on the scale of the slider [a]SL, and the touch point P was moved to the left L or right R (step A13 (Yes)), the minimum value and maximum value are increased/decreased by the same value in accordance with the direction of movement of the point P, and are thus changed (step A14).

Specifically, as illustrated in part (A) of FIG. 10, if the one-point touch P is moved to the right on the scale of the slider [a]SL, a minimum value “−10” and a maximum value “10” are decreased by the same value “1” in accordance with the distance of movement of the point P, and are changed to a minimum value “−11” (min) and a maximum value “9” (max) (step A13, A14).

In addition, as illustrated in part (B) of FIG. 10, if the one-point touch P is moved to the left on the scale of the slider [a]SL, the minimum value “−11” and a maximum value “9” are increased by the same value “1” in accordance with the distance of movement of the point P, and are changed to a minimum value “−10” (min) and a maximum value “10” (max) (step A13, A14).

In this case, too, like the above, the variation range minimum/maximum value-adaptive figure distinguishable display process is executed (step AB), and the thin-broken-line frame Tmin, which surrounds the minimum value of the slider [a]SL, and the thick-broken-line frame Tmax, which surrounds the maximum value, are distinguishably displayed (step B1). Further, the graph figure y2min in the case of setting the coefficient a at the minimum value is distinguishably displayed by a thin broken line, and the graph figure y2max in the case of setting the coefficient a at the maximum value is distinguishably displayed by a thick broken line (step B2).

Thereby, the entirety of the variation range of the coefficient a can be lowered or raised in parallel with the direction of movement of the one-point touch P by the simple operation, that is, the movement to the left/right by the one-point touch P on the slider [a]SL. Moreover, the graph figure y2min and graph figure y2max, which correspond to the minimum value and maximum value of the variation range, can easily be confirmed, and the variation of the graph figure y2, which corresponds to the function expression y2 with the coefficient, can be analyzed with high predictability.

Parts (A1), (A2), (A3), (B), (C1), (C2), (C3) and (D) of FIG. 11 illustrate a change operation (part 3) of the slider SL corresponding to a user operation according to the slider change process of the graph scientific calculator 10.

As illustrated in part (A1) of FIG. 11, if it is determined that a one-point touch P was executed on a part of the tab T of the slider [a]SL, and the touch point P was moved in the upward direction Up (step A11 (Yes)), an increment value (step value) of variation of the set value by the slider [a]SL is changed to increase in accordance with the amount of movement of the touch point P in the upward direction Up (in this example, the increment value is changed from “1” to “2”) (step A12).

Then, as illustrated in part (A2) of FIG. 11, the scale width of the slider [a]SL is changed from “1” to “2” in accordance with the change of the increment value of variation of the set value, and the width of the tab T is also changed in accordance with this scale width (step A10).

Here, in the case in which the current value by the slider [a]SL is set at “2”, as illustrated in parts (A1) and (A2) of FIG. 11, if the tab T is touched and moved to the right R by one step, the current value is changed and set to “4” in accordance with the increment value “2” after the change, as illustrated in part (A3) of FIG. 11 (step S12, S13).

On the other hand, as illustrated in part (C1) of FIG. 11, if it is determined that a one-point touch P was executed on a part of the tab T of the slider [a]SL, and the touch point P was moved in the downward direction Dw (step A11 (Yes)), an increment value (step value) of variation of the set value by the slider [a]SL is changed to decrease in accordance with the amount of movement of the touch point P in the downward direction Dw (in this example, the increment value is changed from “1” to “0.5”) (step A12).

Then, as illustrated in part (C2) of FIG. 11, the scale width of the slider [a]SL is changed from “1” to “0.5” in accordance with the change of the increment value of variation of the set value, and the width of the tab T is also changed in accordance with this scale width (step A10).

Here, in the case in which the current value by the slider [a]5L is set at “1”, as illustrated in parts (C1) and (C2) of FIG. 11, if the tab T is touched and moved to the right R by one step, the current value is changed and set to “1.5” in accordance with the increment value “0.5” after the change, as illustrated in part (C3) of FIG. 11 (step S12, S13).

In addition, as illustrated in part (B) of FIG. 11, if it is determined that a two-point touch P1, P2 was executed on the part of the tab T of the slider [a]SL and the two touch points P1 and P2 were pinched out (pinch-out Po) in the left-and-right direction (step A8 (Yes)), the increment value (step value) of variation of the set value by the slider [a]SL is changed to increase in accordance with the amount of pinch-out between the two touch points P1 and P2 (step A9).

Then, the scale width of the slider [a]SL is changed to increase in accordance with the change of the increment value of variation of the set value, and the width of the tab T is also changed to increase in accordance with this scale width (step A10).

On the other hand, as illustrated in part (D) of FIG. 11, if it is determined that a two-point touch P1, P2 was executed on the part of the tab T of the slider [a]SL and the two touch points P1 and P2 were pinched in (pinch-in Pi) in the left-and-right direction (step A8 (Yes)), the increment value (step value) of variation of the set value by the slider [a]SL is changed to decrease in accordance with the amount of pinch-in between the two touch points P1 and P2 (step A9).

Then, the scale width of the slider [a]SL is changed to decrease in accordance with the change of the increment value of variation of the set value, and the width of the tab T is also changed to decrease in accordance with this scale width (step A10).

Thereby, the increment value (step value) of variation of the set value by the slider [a]SL can be changed by the simple operation, such as by moving the one-point touch P on the tab T of the slider [a]SL in the up-and-down direction, or by pinching out/in (Po/Pi) the two touch points P1 and P2. In addition, the graph figure y2, which corresponds to the function expression y2 with the coefficient, can easily be changed to decrease or increase, and can be analyzed.

(Figure Mode)

FIG. 12 is a flowchart illustrating a figure display control process which is executed by a figure mode of the graph scientific calculator 10.

Parts (A) and (B) of FIG. 13 illustrate a display operation corresponding to a user operation based on the figure display control process of the graph scientific calculator 10.

If the [Geometry] icon GM is touch-operated from the main menu M displayed on the touch panel display 13 and the figure mode is set, a figure display control process illustrated in FIG. 12 is started.

On a figure screen Ge of the touch panel display unit 13 on which this figure display control process was started, if a drawing [Draw] function is selected (step C1 (Yes)) in accordance with a user operation, and a basic figure (Basic figure) function is selected (step C2 (Yes)) and furthermore the kind of figure is selected (step C3), a figure area D is displayed, on which a figure of the selected kind (in this example, a triangle) can be drawn.

On this figure area D, if vertices A, B and C, which correspond to a triangle that is arbitrarily chosen by a user, are touched-operated and input (step C4), a figure of a triangle (ABC) corresponding to the respective input vertices is drawn and displayed (step C5).

As regards this figure of the triangle (ABC), if a side (AB) and a side (BC), which are figure parts, are touch-operated and selected in order to measure an angle (interior angle) ∠B of the vertex B of the triangle (ABC), the kind of line of the selected side (AB) and side (BC) is changed to a thick line, a selected-state mark m is added to the sides (AB) and (BC), and the sides (AB) and (BC) are distinguishably displayed. At this time, in a measurement box M above the figure screen Ge, an angle icon Ia for setting an angle as a measurement item is displayed as a default, and an angle “60” formed between the selected sides (AB) and (BC) is measured and displayed.

Then, in a drawing function list (not shown) which is displayed in a pull-down form on the figure area D, if a setting item [Slider] of a slider is selected (step S6 (Yes)), it is determined that figure parts in the selected state are the two sides (AB) and (BC). Then, in a slider selection menu which is further displayed in a pull-down form from the setting item [Slider] of the slider, if an angle [Angle] is touch-operated and selected from between an angle [Angle] and a length [Length] that are measurement items, with respect to which set values can be changed for the figure parts (two sides (AB) and (BC)), a slider [Angle]SL for changing the set value of the angle is displayed on a free area of the figure area D (step C8). Incidentally, the shape of the figure is determined by the set value of the angle [Angle] or length [Length].

Here, if the tab T of the slider [Angle]SL is touch-operated and moved (step C9, C10 (Yes)), a set value corresponding to the position after the movement is set based on an increment value (step value) corresponding to the movement of the tab T (step C11), and the set value of the measurement item (angle), which is displayed in the measurement box M, is changed to this set value that was set (step C14).

Then, in accordance with the change of the set value of the measurement item (angle), the angle formed between the figure parts (side (AB) and side (BC)) in the selected state is changed, and the figure of the triangle (ABC) is altered and displayed (step C15).

In addition if the left button Ed or right button Bu of the slider [Angle]SL is touch-operated (step C12 (Yes)), a set value, which was increased or decreased based on the step-unit increment value (step value) corresponding to the touch operation of the left button Bd or right button Bu, is set (step C13), and the set value of the measurement item (angle), which is displayed in the measurement box M, is changed to this set value that was set (step C14).

Then, like the case of operating the tab T, in accordance with the change of the set value of the measurement item (angle), the angle formed between the figure parts (side (AB) and side (BC)) in the selected state is changed, and the figure of the triangle (ABC) is altered and displayed (step C15).

On the other hand, like the slider change process in the graph mode, in the case where the figure of the triangle (ABC) is to be analyzed by altering the figure of the triangle (ABC) in a manner to become larger or smaller by widening or narrowing the present variation range [0°˜180°] of the measurement item (angle) by the slider [Angle]SL, if a part of the slider [Angle]SL, excluding the left button [←] Bd, right button [→] Bu and tab T, is continuously touch-operated and long-pressed for a predetermined time (e.g. three seconds) or more, it is determined that a change operation for changing the slider variation range was executed (step C16 (yes)), and a transition occurs to the above-described slider change process illustrated in FIG. 5 (step CA).

Then, in this figure mode, too, the same slider change process as described above (steps A1˜A14/B1, B2) is executed. The variation range of the set value and the increment value (step value) of variation by the slider [Angle]SL can easily be changed by simply executing a two-point touch or a one-point touch on the slider [Angle]SL. Furthermore, figures ∠Bmin and ∠Bmax, in which the angle ∠B was changed in accordance with the minimum value and maximum value of the changed variation range of the set value, can be distinguishably displayed and can be viewed. Incidentally, either the figure ∠Bmin or the figure ∠Bmax, in which the angle ∠B was changed, may be displayed.

For example, in accordance with the pinch-in Pi by the two-point touch P1, P2 on the scale of the slider [Angle] SL, as illustrated in part (A) of FIG. 13, the variation range [0˜180] is changed to [30˜120], as illustrated in part (B) of FIG. 13 (step A6, A7).

Then, each time the variation range of the slider [Angle]SL is changed, the variation range minimum/maximum value-adaptive figure distinguishable display process is executed like the above (step A5 (No)→A6, A7, AB), the thin-broken-line frame Tmin surrounding the minimum value of the slider [Angle]SL and the thick-broken-line frame Tmax surrounding the maximum value of the slider [Angle]SL are distinguishably displayed (step B1). Furthermore, the figure ∠Bmin in the case of setting the measurement item (angle ∠B) at the minimum value is distinguishably displayed by a thin broken line, and the figure ∠Bmax in the case of setting the measurement item (angle ∠B) at the maximum value is distinguishably displayed by a thick broken line (step B2).

Thereby, the variation range of the measurement item (angle ∠B) can be narrowed or widened by the simple operation, that is, the pinch operation (Pi/Po) on the slider [Angle]SL. Moreover, the figure ∠Bmin and the figure ∠Bmax, which correspond to the minimum value and maximum value of the variation range, can easily be confirmed, and the variation of the figure of the triangle (ABC) can be analyzed with good estimation.

Thus, according to the graph/figure display control function of the graph scientific calculator 10 with the above-described structure, if a figure, such as a graph, a line or a polygon, is displayed on the touch panel display unit 13 and the set value for forming the figure is changed by a user operation of the slider SL displayed on the touch panel display unit 13, the figure is altered and displayed. Then, if the two-point touch P1, P2 is executed on the slider SL and the distance between the two points P1 and P2 is widened or narrowed, the minimum value and maximum value of the variation range of the set value, which can be changed by the slider SL, is varied such that this variation range is widened or narrowed in accordance with the widened or narrowed distance.

Thereby, the variation range of the set value of the parameter for altering the figure can very easily be changed, and this figure can freely be moved to become smaller or larger.

Additionally, according to the graph/figure display control function of the graph scientific calculator 10 with the above-described structure, a figure corresponding to the minimum value of the variation range of the set value and a figure corresponding to the maximum value of the variation range of the set value are distinguishably displayed together with the figure corresponding to the current set value.

Thereby, the user can view the figure in the case of setting the set value of the figure at the minimum value by the slider SL and the figure in the case of setting the set value of the figure at the maximum value by the slider SL, such that these figures are distinguished from the figure corresponding to the current set value, without operating the left button Bd, right button Bu or tab T of the slider SL.

Additionally, according to the graph/figure display control function of the graph scientific calculator 10 with the above-described structure, the distinguishable display mode of the figure corresponding to the minimum value of the variation range of the slider SL and the distinguishable display mode of the figure corresponding to the maximum value of the variation range of the slider SL are made to agree with the distinguishable display mode of the minimum value in the slider SL and the distinguishable display mode of the maximum value in the slider SL.

Thereby, the figure corresponding to the minimum value of the variation range of the slider SL and the figure corresponding to the maximum value of the variation range can clearly be distinguished and confirmed.

Additionally, according to the graph/figure display control function of the graph scientific calculator 10 with the above-described structure, if the distance between the two touch points P1 and P2 is widened or narrowed along the variation range of the set value of the slider SL, the variation range of the set value, which is changeable by the slider SL, is changed in accordance with the widened or narrowed distance in a manner to widen or narrow equally on the minimum value side and the maximum value side.

Thereby, the variation range of the parameter for altering the figure can be changed in a well-balanced manner on the minimum value side and the maximum value side, by the very simple and easy-to-understand operation.

Additionally, according to the graph/figure display control function of the graph scientific calculator 10 with the above-described structure, if one of the two touch points P1 and P2 is fixed and the other is pinched out or pinched in along the variation range of the set value of the slider SL, the minimum value or maximum value existing in the direction of the fixed point is fixed, and the maximum value or minimum value existing in the direction of the pinched-out or pinched-in point is changed in accordance with the distance of the pinch-out or pinch-in.

Thereby, the variation range of the parameter for altering the figure can be changed by the very simple and easy-to-understand operation by selecting the minimum value side or maximum value side.

Additionally, according to the graph/figure display control function of the graph scientific calculator 10 with the above-described structure, if a one-point touch P is executed on the slider SL, and the position of the one-point touch P is moved in one direction or in the other direction along the variation range of the set value, both the minimum value and the maximum value of the variation range of the set value are changed to increase or decrease in accordance with the distance of movement.

Thereby, the variation range of the parameter for altering the figure can be shifted to the upper side or lower side, and changed, by the very simple and easy-to-understand operation.

Additionally, according to the graph/figure display control function of the graph scientific calculator 10 with the above-described structure, if a one-point touch P is executed on the tab T of the slider SL, and the touch point P is moved in the upward direction Up or downward direction Dw, the increment value (step value) of variation of the set value, which corresponds to the unit of movement of the tab T, is changed to increase or decrease, and the width of the tab T is also changed in accordance with the change of the increment value.

The methods of the respective processes by the graph scientific calculator 10 described in each of the embodiments, that is, the respective methods of the graph display control process illustrated in the flowchart of FIG. 4, the slider change process illustrated in the flowchart of FIG. 5 and the figure display control process illustrated in the flowchart of FIG. 12, can all be stored as computer-executable programs in a medium of an external storage device, such as a memory card (ROM card, RAM card, etc.), a magnetic disk (floppy disk, hard disk, etc.), an optical disc (CD-ROM, DVD, etc.), or a semiconductor memory, and can be distributed. In addition, the computer (controller) of the electronic device, which includes the display that is capable of user input, reads the program, which is stored in the medium of the external storage device, into the storage device, and the operation is controlled by this read-in program. Thereby, it is possible to realize the graph display function and figure display function, which have been described in the embodiments, and to execute the same processes by the above-described methods.

In addition, the data of the program for realizing each of the above-described methods can be transmitted on a communication network in the form of a program code, and the data of the program can be taken in the electronic device, which includes the display that is capable of user input, from a computer apparatus (program server) connected to this communication network, and stored in the storage device, thereby realizing the above-described graph display function and figure display function.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A figure display apparatus comprising a display, a touch panel, and a processor,
the processor being configured to:
cause the display to display a first figure;
cause the display to display an operation display element for changing, in accordance with a user operation, a set value for determining the displayed first figure;
cause the display to display a second figure being changed from the displayed first figure in accordance with a user operation of the displayed operation display element; and
change a variation range of the set value by the operation display element in accordance with a user's multi-touch operation.

2. The figure display apparatus of claim 1, wherein the processor is further configured to:
cause the display to display at least either (i) a third figure corresponding to a minimum value of the variation range of the set value or (ii) a forth figure corresponding to a maximum value of the variation range of the set value, distinguishably from the displayed first figure.

3. The figure display apparatus of claim 2, wherein the processor is further configured to:
cause the display to distinguishably display, in different display styles, the minimum value and the maximum value of the variation range of the set value by the operation display element; and
cause the display to distinguishably display, the third figure and the forth figure in display styles corresponding to the display styles of the minimum value and the display style of the maximum value respectively.

4. The figure display apparatus of claim 1, wherein the processor is further configured to:
change, when the variation range of the set value by the operation display element is to be changed in accordance with the multi-touch operation of a user, the variation range of the set value by the operation display element (i) in a manner to widen the variation range in accordance with a widened distance between a plurality of touch positions of the user, and (ii) in a manner to narrow the variation range in accordance with a narrowed distance between the plurality of touch positions of the user.

5. The figure display apparatus of claim 1, wherein the processor is further configured to:
change when the variation range of the set value by the operation display element is to be changed in accordance with the multi-touch operation of a user, the variation range of the set value by the operation display element such that, (i) if one of two touch positions of the multi-touch operation of the user is fixed and the other of the two touch positions is widened, a minimum value or a maximum value of the variation range, which corresponds to the one of the touch position, is fixed, and the maximum value or the minimum value of the variation range, which corresponds to the other touch position, is changed to increase in accordance with a distance of the widened touch position, and (ii) if one of two touch positions of the multi-touch operation of a user is fixed and the other of the two touch positions is narrowed, the minimum value or the maximum value of the variation range, which corresponds to the one touch position, is fixed, and the maximum value or the minimum value of the variation range, which corresponds to the other touch position, is changed to decrease in accordance with a distance of the narrowed touch position.

6. The figure display apparatus of claim 1, wherein the processor is further configured to:
change, when the variation range of the set value by the operation display element is to be changed in accordance with a touch operation of a user, the variation range of the set value by the operation display element such that, if a touch position of a user is moved in one direction or the other direction, which corresponds to a direction of variation of the variation range, both the minimum value and the maximum value of the variation range are changed to decrease or increase.

7. The figure display apparatus of claim 1, wherein the processor is further configured to:
change, when a touch position of a user was moved in one direction or the other direction, which is perpendicular to a direction corresponding to the variation range of the set value of the figure by the operation display element, a unit variation width of the set value, which corresponds to a user operation of the operation display element, in a manner to increase or decrease.

8. The figure display apparatus of claim 7, wherein the operation display element includes an operation element configured to move in accordance with a user operation within the variation range of the set value, and to change the set value in units of the unit variation width, and
the processor is further configured to change a width of the operation element in accordance with the changed unit variation width of the set value.

9. The figure display apparatus of claim 1, wherein the figure is a graph figure, and
the set value of the figure is a set value of a coefficient included in a function expression corresponding to the graph figure.

10. The figure display apparatus of claim 1, wherein the set value of the figure is a set value of a measurable figure part of the figure.

11. An figure display method of an electronic apparatus comprising a display, a touch panel, and a processor,
the processor being configured to:
cause the display to display a figure;
cause the display to display an operation display element for changing, in accordance with a user operation, a set value for determining the displayed first figure;
cause the display to display a second figure being changed from the displayed first figure in accordance with a user operation of the displayed operation display element; and
change a variation range of the set value by the operation display element in accordance with a user's multi-touch operation.

12. A non-transitory computer readable storage medium having stored therein a figure display program of an electronic apparatus including a display, a touch panel and a processor, the program causing the processor to:
cause the display to display a figure;
cause the display to display an operation display element for changing, in accordance with a user operation, a set value for determining the displayed first figure;
cause the display to display a second figure being changed from the displayed first figure in accordance with a user operation of the displayed operation display element; and
change a variation range of the set value by the operation display element in accordance with a user's multi-touch operation.
